(19) United States
(12) Patent Application Publication
(10) Pub. No.: US 2024/0241227 A1
(43) Pub. Date: Jul. 18, 2024

(54) DISTANCE MEASURING DEVICE AND DISTANCE MEASURING METHOD

(71) Applicant: Sony Semiconductor Solutions Corporation, Kanagawa (JP)

(72) Inventors: Takahiro Kado, Kanagawa (JP); Takuya Yokoyama, Kanagawa (JP)

(21) Appl. No.: 18/559,730

(22) PCT Filed: Feb. 15, 2022
(86) PCT No.: PCT/JP22/05799

§ 371 Date: Nov. 8, 2023

(30) Foreign Application Priority Data
Jun. 17, 2021 (JP) 2021-100953

(51) Int. Cl. G01S 7/484; G01S 7/4863; G01S 17/42

(52) U.S. Cl. CPC G01S 7/484; G01S 7/4863; G01S 17/42

(57) ABSTRACT

The present technology relates to a distance measuring device and a distance measuring method capable of improving the resolution of the distance measuring device while suppressing the number of light-receiving elements.

The distance measuring device includes a light source that emits pulsed irradiation light; a scanning unit that scans the irradiation light in a first direction; a light-receiving unit that receives incident light including reflected light with respect to the irradiation light; a distance measuring unit that performs distance measurement based on the incident light; and a control unit that shifts an irradiation direction of the irradiation light in the first direction within a range smaller than a resolution in the first direction between frames by controlling at least one of the light source and the scanning unit. The present technology can be applied to LiDAR, for example.

### TECHNICAL FIELD

The present technology relates to a distance measuring device and a distance measuring method, and more particularly to a distance measuring device and a distance measuring method with improved resolution.

### BACKGROUND ART

Conventionally, a distance measuring device has been proposed in which the resolution is improved by shifting the positions of pixels of a pixel array unit that receives the reflected light of the irradiation light emitted from a light source in the row direction and the column direction each time scanning is performed (see PTL 1, for example).

### CITATION LIST

### Patent Literature

[PTL 1]
JP 2020-118570A

### SUMMARY

### Technical Problem

However, in the distance measuring device of the invention described in PTL 1, the pixels in which the light-receiving elements are two-dimensionally arranged are two-dimensionally arranged in the pixel array unit, and the number of light-receiving elements required increases.

The present technology has been made in view of such circumstances, and an object thereof is to improve the resolution of a distance measuring device while suppressing the number of light-receiving elements.

### Solution to Problem

A distance measuring device according to one aspect of the present technology includes a light source that emits pulsed irradiation light; a scanning unit that scans the irradiation light in a first direction; a light-receiving unit that receives incident light including reflected light with respect to the irradiation light; a distance measuring unit that performs distance measurement based on the incident light; and a control unit that shifts an irradiation direction of the irradiation light in the first direction within a range smaller than a resolution in the first direction between frames by controlling at least one of the light source and the scanning unit.

A distance measurement method according to one aspect of the present technology is a distance measuring method in a distance measuring device including a light source that emits pulsed irradiation light; a scanning unit that scans the irradiation light in a predetermined direction; a light-receiving unit that receives incident light including reflected light with respect to the irradiation light; and a distance measuring unit that performs distance measurement based on the incident light, the distance measuring device executing: shifting an irradiation direction of the irradiation light in the predetermined direction within a range smaller than a resolution in the predetermined direction between frames by controlling at least one of the light source and the scanning unit.

In one aspect of the present technology, the irradiation direction of the irradiation light is shifted in the predetermined direction within a range smaller than the resolution in the predetermined direction between frames.

### BRIEF DESCRIPTION OF DRAWINGS

FIG. 1 is a block diagram showing a configuration example of a vehicle control system.

FIG. 2 is a diagram showing an example of sensing areas.

FIG. 3 is a block diagram showing an embodiment of LiDAR to which the present technology is applied.

FIG. 4 is a diagram showing a configuration example of an optical system of LiDAR.

FIG. 5 is a diagram showing a configuration example of a pixel array unit of a light-receiving unit of LiDAR.

FIG. 6 is a diagram showing a first example of irradiation directions of irradiation light.

FIG. 7 is a diagram showing a second example of irradiation directions of irradiation light.

FIG. 8 is a diagram showing a first example of a method of shifting the unit field of view.

FIG. 9 is a diagram showing a second example of a method of shifting the unit field of view.

### DESCRIPTION OF EMBODIMENTS

An embodiment for implementing the present technique will be described below. The description will be made in the following order.
1. Configuration example of vehicle control system
2. Embodiment
3. Modification example
4. Others

### 1. Configuration Example of Vehicle Control System

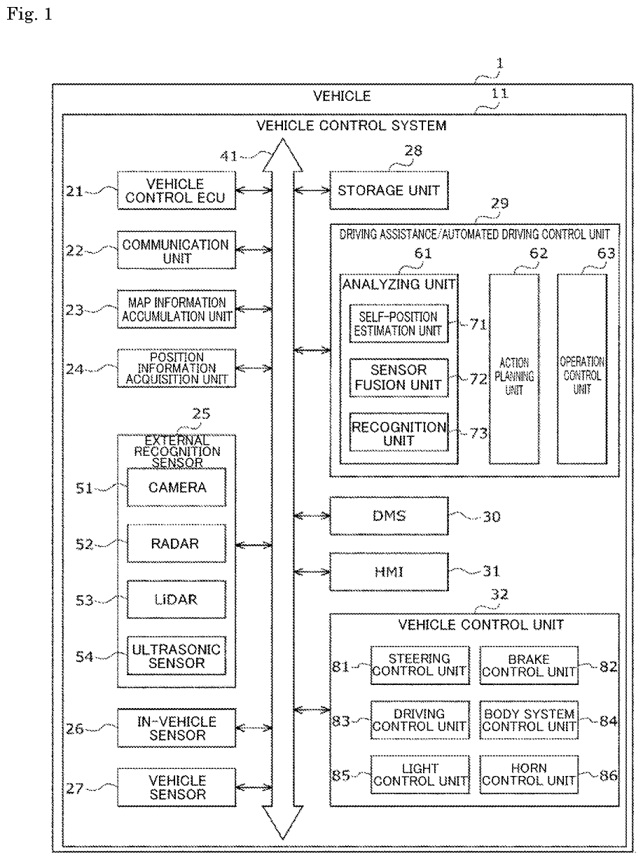

FIG. 1 is a block diagram showing a configuration example of a vehicle control system 11 being an example of a mobile apparatus control system to which the present technique is to be applied.

The vehicle control system 11 is provided in a vehicle 1 and performs processing related to driving support and automated driving of the vehicle 1.

The vehicle control system 11 includes a vehicle control electronic control unit (ECU) 21, a communication unit 22, a map information accumulation unit 23, a position information acquisition unit 24, an external recognition sensor 25, an in-vehicle sensor 26, a vehicle sensor 27, a storage unit 28, a driving assistance/automated driving control unit 29, a driver monitoring system (DMS) 30, a human machine interface (HMI) 31, and a vehicle control unit 32.

The vehicle control ECU 21, the communication unit 22, the map information accumulation unit 23, the position information acquisition unit 24, the external recognition sensor 25, the in-vehicle sensor 26, the vehicle sensor 27, the storage unit 28, the driving assistance/automated driving control unit 29, the driver monitoring system (DMS) 30, the human machine interface (HMI) 31, and the vehicle control unit 32 are connected via a communication network 41 so as to be able to communicate with each other. The communication network 41 is configured of, for example, a vehicle-mounted communication network conforming to a digital two-way communication standard such as a controller area network (CAN), a local interconnect network (LIN), a local area network (LAN), a FlexRay (registered trademark), or Ethernet (registered trademark), a bus, and the like. The communication network 41 may be used properly depending on the type of data to be transmitted. For example, CAN may be applied to data related to vehicle control, and Ethernet may be applied to large-capacity data. It should be noted that the respective units of the vehicle control system 11 may be connected directly using wireless communication assuming relatively short range communication such as near field communication (NFC) or Bluetooth (registered trademark), for example, without going through the communication network 41.

Hereinafter, when the respective units of the vehicle control system 11 perform communication via the communication network 41, a description of the communication network 41 will be omitted. For example, when the vehicle control ECU 21 and the communication unit 22 communicate via the communication network 41, it is simply described that the vehicle control ECU 21 and the communication unit 22 communicate with each other.

The vehicle control ECU 21 is realized by various processors, such as a central processing unit (CPU) and a micro processing unit (MPU), for example. The vehicle control ECU 21 controls the functions of the entire vehicle control system 11 or a part thereof.

The communication unit 22 communicates with various devices inside and outside of the vehicle, other vehicles, servers, base stations, and the like and performs transmission/reception of various kinds of data. At this time, the communication unit 22 can perform communication using a plurality of communication methods.

Communication with the outside of the vehicle that can be performed by the communication unit 22 will be described schematically. The communication unit 22 communicates with a server or the like that is present on an external network (hereinafter referred to as an external server) according to a wireless communication method such as 5G (5th Generation Mobile Communication System), LTE (Long Term Evolution), or DSRC (Dedicated Short Range Communications) via a base station or an access point. The external network with which the communication unit 22 communicates is, for example, the Internet, a cloud network, or a business-specific network. The communication method according to which the communication unit 22 performs communication with the external network is not particularly limited as long as it is a wireless communication method that enables digital two-way communication at a communication speed of a predetermined value or more and a distance of a predetermined value or more.

Further, for example, the communication unit 22 can communicate with a terminal present in the vicinity of the host vehicle using P2P (Peer To Peer) technology. Terminals in the vicinity of the host vehicle are, for example, terminals worn by mobile bodies such as pedestrians and bicycles that move at a relatively low speed, terminals installed at fixed locations such as stores, or MTC (Machine Type Communication) terminal. Furthermore, the communication unit 22 can also perform V2X communication. Examples of V2X communication include vehicle-to-vehicle communication with another vehicle, vehicle-to-infrastructure communication with a roadside device or the like, vehicle-to-home communication with home, and vehicle-to-pedestrian communication with a terminal possessed by a pedestrian or the like.

The communication unit 22 can receive, for example, a program for updating software that controls the operation of the vehicle control system 11 (Over The Air). The communication unit 22 can also receive map information, traffic information, information around the vehicle 1, and the like from the outside. Further, for example, the communication unit 22 can transmit information about the vehicle 1, information about the surroundings of the vehicle 1, and the like to the outside. The information about the vehicle 1 that the communication unit 22 transmits to the outside includes, for example, data indicating the state of the vehicle 1, recognition results by the recognition unit 73, and the like. Furthermore, for example, the communication unit 22 performs communication accommodating vehicle emergency notification systems such as eCall.

For example, the communication unit 22 receives electromagnetic waves transmitted by a Vehicle Information and Communication System (VICS (registered trademark)) using a radio beacon, a light beacon, FM multiplex broadcast, and the like.

Communication with the inside of the vehicle that can be performed by the communication unit 22 will be described schematically. The communication unit 22 can communicate with each device in the vehicle using, for example, wireless communication. The communication unit 22 can perform wireless communication with devices in the vehicle using a communication method such as wireless LAN, Bluetooth, NFC, and WUSB (Wireless USB) that enables digital two-way communication at a communication speed higher than a predetermined value. Not limited to this, the communication unit 22 can also communicate with each device in the vehicle using wired communication. For example, the communication unit 22 can communicate with each device in the vehicle by wired communication via a cable connected to a connection terminal (not shown). The communication unit 22 can communicate with each device in the vehicle according to a communication method such as USB (Universal Serial Bus), HDMI (High-Definition Multimedia Interface) (registered trademark), and MHL (Mobile High-definition Link) that enables digital two-way communication at a predetermined communication speed or higher by wired communication.

In this case, a device in the vehicle refers to, for example, a device not connected to the communication network 41 in the vehicle. Examples of devices in the vehicle include a mobile device or a wearable device carried by an occupant such as a driver or an information device which is carried aboard the vehicle to be temporarily installed therein.

The map information accumulation unit 23 accumulates one or both of maps acquired from the outside and maps created by the vehicle 1. For example, the map information accumulation unit 23 accumulates a three-dimensional high-precision map, a global map which is less precise than the high precision map but which covers a wide area, and the like.

The high precision map is, for example, a dynamic map, a point cloud map, a vector map, or the like. A dynamic map is a map which is composed of four layers of dynamic information, quasi-dynamic information, quasi-static information, and static information and which is provided to the vehicle 1 by an external server or the like. A point cloud map is a map composed of a point cloud (point cloud data). A vector map is, for example, a map adapted to ADAS (Advanced Driver Assistance System) and AD (Autonomous Driving) by associating traffic information such as lanes and positions of traffic lights with a point cloud map.

For example, the point cloud map and the vector map may be provided by an external server or the like or created by the vehicle 1 as a map to be matched with a local map (to be described later) based on sensing results by a camera 51, a radar 52, a LiDAR 53 or the like and accumulated in the map information accumulation unit 23. In addition, when a high-precision map is to be provided by an external server or the like, in order to reduce communication capacity, map data of, for example, a square with several hundred meters per side regarding a planned path to be traveled by the vehicle 1 is acquired from the external server or the like.

The position information acquisition unit 24 receives GNSS signals from GNSS (Global Navigation Satellite System) satellites and acquires position information of the vehicle 1. The acquired position information is supplied to the driving assistance/automated driving control unit 29. Note that the position information acquisition unit 24 is not limited to the method using GNSS signals, and may acquire position information using beacons, for example.

The external recognition sensor 25 includes various sensors used to recognize a situation outside of the vehicle 1 and supplies sensor data from each sensor to each unit of the vehicle control system 11. The external recognition sensor 25 may include any type of or any number of sensors.

For example, the external recognition sensor 25 includes a camera 51, the radar 52, the LiDAR (Light Detection and Ranging, Laser Imaging Detection and Ranging) 53, and an ultrasonic sensor 54. The configuration is not limited to this, and the external recognition sensor 25 may be configured to include one or more types of sensors among the camera 51, the radar 52, the LiDAR 53, and the ultrasonic sensor 54. The numbers of cameras 51, radars 52, LiDARs 53, and ultrasonic sensors 54 are not particularly limited as long as they can be realistically installed in the vehicle 1. Moreover, the type of sensor provided in the external recognition sensor 25 is not limited to this example, and the external recognition sensor 25 may be provided with other types of sensors. An example of the sensing area of each sensor included in the external recognition sensor 25 will be described later.

Note that the imaging method of the camera 51 is not particularly limited. For example, cameras of various types such as a ToF (Time Of Flight) camera, a stereo camera, a monocular camera, and an infrared camera, which are capable of distance measurement, can be applied to the camera 51 as necessary. The camera 51 is not limited to this, and may simply acquire a photographed image regardless of distance measurement.

In addition, for example, the external recognition sensor 25 can include an environment sensor for detecting the environment with respect to the vehicle 1. The environment sensor is a sensor for detecting the environment such as weather, climate, brightness, and the like, and can include various sensors such as raindrop sensors, fog sensors, sunshine sensors, snow sensors, and illuminance sensors.

Furthermore, for example, the external recognition sensor 25 includes a microphone to be used to detect sound around the vehicle 1, a position of a sound source, or the like.

The in-vehicle sensor 26 includes various sensors for detecting information inside of the vehicle and supplies sensor data from each sensor to each unit of the vehicle control system 11. The types and number of various sensors included in the in-vehicle sensor 26 are not particularly limited as long as they are the types and number that can be realistically installed in the vehicle 1.

For example, the in-vehicle sensor 26 may include one or more of cameras, radar, seat sensors, steering wheel sensors, microphones, biometric sensors. As the camera provided in the in-vehicle sensor 26, for example, cameras of various shooting methods capable of distance measurement, such as a ToF camera, a stereo camera, a monocular camera, and an infrared camera, can be used. The camera included in the in-vehicle sensor 26 is not limited to this, and may simply acquire a photographed image regardless of distance measurement. The biosensor included in the in-vehicle sensor 26 is provided, for example, in a seat or a steering wheel, and detects various types of biological information of an occupant such as a driver.

The vehicle sensor 27 includes various sensors for detecting a state of the vehicle 1 and supplies sensor data from each sensor to each unit of the vehicle control system 11. The types and number of various sensors included in the vehicle sensor 27 are not particularly limited as long as the types and number are practically installable in the vehicle 1.

For example, the vehicle sensor 27 includes a velocity sensor, an acceleration sensor, an angular velocity sensor (gyroscope sensor), and an inertial measurement unit (IMU) integrating them. For example, the vehicle sensor 27 includes a steering angle sensor which detects a steering angle of the steering wheel, a yaw rate sensor, an accelerator sensor which detects an operation amount of the accelerator pedal, and a brake sensor which detects an operation amount of the brake pedal. For example, the vehicle sensor 27 includes a rotation sensor which detects a rotational speed of an engine or a motor, an air pressure sensor which detects air pressure of a tire, a slip ratio sensor which detects a slip ratio of a tire, and a wheel speed sensor which detects a rotational speed of a wheel. For example, the vehicle sensor 27 includes a battery sensor which detects remaining battery life and temperature of a battery and an impact sensor which detects an impact from the outside.

The storage unit 28 includes at least one of a nonvolatile storage medium and a volatile storage medium, and stores data and programs. The storage unit 28 is used, for example, as an EEPROM (Electrically Erasable Programmable Read Only Memory) and a RAM (Random Access Memory). As a storage medium, a magnetic storage device such as an HDD (Hard Disc Drive), a semiconductor storage device, an optical storage device, and a magneto-optical storage device can be applied. The storage unit 28 stores various programs and data used by each unit of the vehicle control system 11. For example, the storage unit 28 includes an EDR (Event Data Recorder) and a DSSAD (Data Storage System for Automated Driving), and stores information on the vehicle 1 and information acquired by the in-vehicle sensor 26 before and after an event such as an accident.

The driving assistance/automated driving control unit 29 controls driving support and automated driving of the vehicle 1. For example, the driving assistance/automated driving control unit 29 includes an analyzing unit 61, an action planning unit 62, and an operation control unit 63.

The analyzing unit 61 performs analysis processing of the vehicle 1 and its surroundings. The analyzing unit 61 includes a self-position estimation unit 71, a sensor fusion unit 72, and a recognition unit 73.

The self-position estimation unit 71 estimates a self-position of the vehicle 1 based on sensor data from the external recognition sensor 25 and the high-precision map accumulated in the map information accumulation unit 23. For example, the self-position estimation unit 71 estimates a self-position of the vehicle 1 by generating a local map based on sensor data from the external recognition sensor 25 and matching the local map and the high-precision map with each other. A position of the vehicle 1 is based on, for example, a center of the rear axle.

The local map is, for example, a three-dimensional high precision map, an occupancy grid map, or the like created using a technique such as SLAM (Simultaneous Localization and Mapping). An example of a three-dimensional high-precision map is the point cloud map described above. An occupancy grid map is a map which is created by dividing a three-dimensional or two-dimensional space around the vehicle 1 into grids of a predetermined size and which indicates an occupancy of an object in grid units. The occupancy of an object is represented by, for example, a presence or an absence of the object or an existence probability of the object. The local map is also used in, for example, detection processing and recognition processing of surroundings of the vehicle 1 by the recognition unit 73.

It should be noted that the self-position estimation unit 71 may estimate a self-position of the vehicle 1 based on the position information acquired by the position information acquisition unit 24 and sensor data from the vehicle sensor 27.

The sensor fusion unit 72 performs sensor fusion processing for obtaining new information by combining sensor data of a plurality of different types (for example, image data supplied from the camera 51 and sensor data supplied from the radar 52). Methods of combining sensor data of a plurality of different types include integration, fusion, and association.

The recognition unit 73 performs detection processing for detecting the situation outside of the vehicle 1 and recognition processing for recognizing the situation outside of the vehicle 1.

For example, the recognition unit 73 performs detection processing and recognition processing of surroundings of the vehicle 1 based on information from the external recognition sensor 25, information from the self-position estimation unit 71, information from the sensor fusion unit 72, and the like.

Specifically, for example, the recognition unit 73 performs detection processing, recognition processing, and the like of an object around the vehicle 1. The detection processing of an object refers to, for example, processing for detecting the presence or absence, a size, a shape, a position, a motion, or the like of an object. The recognition processing of an object refers to, for example, processing for recognizing an attribute such as a type of an object or identifying a specific object. However, a distinction between detection processing and recognition processing is not always obvious and an overlap may sometimes occur.

For example, the recognition unit 73 detects an object around the vehicle 1 by performing clustering in which a point cloud based on sensor data obtained by the radar 52 or the LiDAR 53 or the like is classified into blocks of point groups. Accordingly, the presence or absence, a size, a shape, and a position of an object around the vehicle 1 are detected.

For example, the recognition unit 73 detects a motion of the object around the vehicle 1 by performing tracking to track a motion of a cluster of point clouds classified by clustering. Accordingly, a speed and traveling direction (a motion vector) of the object around the vehicle 1 are detected.

For example, the recognition unit 73 detects or recognizes vehicles, persons, bicycles, obstacles, structures, roads, traffic lights, traffic signs, road markings, and the like based on the image data supplied from the camera 51. For example, the recognition unit 73 may recognize the type of an object around the vehicle 1 by performing recognition processing such as semantic segmentation.

For example, the recognition unit 73 can perform recognition processing of traffic rules around the vehicle 1 based on maps accumulated in the map information accumulation unit 23, an estimation result of a self-position obtained by the self-position estimation unit 71, and a recognition result of an object around the vehicle 1 obtained by the recognition unit 73. Through this processing, the recognition unit 73 can recognize the position and state of traffic lights, the content of traffic signs and road markings, the content of traffic restrictions, the lanes in which the vehicle can travel, and the like.

For example, the recognition unit 73 can perform recognition processing of a surrounding environment of the vehicle 1. The surrounding environment to be recognized by the recognition unit 73 includes the weather, temperature, humidity, brightness, road surface conditions, and the like.

The action planning unit 62 creates an action plan of the vehicle 1. For example, the action planning unit 62 creates an action plan by performing processing of path planning and path following.

Path planning (Global path planning) is processing of planning a general path from start to goal. Path planning also includes processing of trajectory generation (local path planning) which is referred to as trajectory planning and which enables safe and smooth travel in the vicinity of the vehicle 1 in consideration of motion characteristics of the vehicle 1 along a planned path.

Path following refers to processing of planning an operation for safely and accurately traveling the path planned by path planning within a planned time. The action planning unit 62 can, for example, calculate the target speed and target angular speed of the vehicle 1 based on the result of this path following processing.

The operation control unit 63 controls operations of the vehicle 1 in order to realize the action plan created by the action planning unit 62.

For example, the operation control unit 63 controls a steering control unit 81, a brake control unit 82, and a drive control unit 83 included in the vehicle control unit 32, which will be described later, to perform acceleration/deceleration control and directional control so that the vehicle 1 proceeds along a trajectory calculated by trajectory planning. For example, the operation control unit 63 performs cooperative control in order to realize functions of ADAS such as collision avoidance or shock mitigation, car-following driving, constant-speed driving, collision warning of host vehicle, and lane deviation warning of host vehicle. For example, the operation control unit 63 performs cooperative control in order to realize automated driving or the like in which a vehicle autonomously travels irrespective of manipulations by a driver.

The DMS 30 performs authentication processing of a driver, recognition processing of a state of the driver, and the like based on sensor data from the in-vehicle sensor 26, input data that is input to the HMI 31 to be described later, and the like. As a state of the driver to be a recognition target, for example, a physical condition, a level of arousal, a level of concentration, a level of fatigue, an eye gaze direction, a level of intoxication, a driving operation, or a posture is assumed.

Alternatively, the DMS 30 may be configured to perform authentication processing of an occupant other than the driver and recognition processing of a state of such an occupant. In addition, for example, the DMS 30 may be configured to perform recognition processing of a situation inside of the vehicle based on sensor data from the in-vehicle sensor 26. As the situation inside of the vehicle to be a recognition target, for example, temperature, humidity, brightness, or odor is assumed.

The HMI 31 inputs various pieces of data, instructions, and the like, and presents various pieces of data to the driver or the like.

Data input by the HMI 31 will be schematically described. The HMI 31 includes an input device for a person to input data. The HMI 31 generates an input signal based on input data, an input instruction, or the like input by an input device and supplies the generated input signal to each unit of the vehicle control system 11. The HMI 31 includes operators such as a touch panel, buttons, switches, and levers as input devices. The HMI 31 is not limited to this, and may further include an input device capable of inputting information by a method other than manual operation using voice, gestures, or the like. Furthermore, the HMI 31 may use, as an input device, a remote control device using infrared rays or radio waves, or an external connection device such as a mobile device or wearable device corresponding to the operation of the vehicle control system 11.

The presentation of data by the HMI 31 will be described schematically. The HMI 31 generates visual information, auditory information, and tactile information for the occupant or outside of the vehicle. In addition, the HMI 31 performs output control for controlling the output, output content, output timing, output method, and the like of each of the generated pieces of information. The HMI 31 generates and outputs, as visual information, for example, information represented by images and light such as an operating screen, a state display of the vehicle 1, a warning display, and a monitor image indicating surroundings of the vehicle 1. The HMI 31 also generates and outputs, as auditory information, information represented by sounds such as voice guidance, warning sounds, warning messages, and the like. Furthermore, the HMI 31 generates and outputs, as tactile information, information that is tactually presented to an occupant by force, vibration, movement, or the like.

As an output device from which the HMI 31 outputs visual information, for example, a display device that presents visual information by displaying an image by itself or a projector device that presents visual information by projecting an image can be applied. In addition to the display device having a normal display, the display device may be a device that displays visual information within the occupant's field of view, such as a head-up display, a transmissive display, and a wearable device with an AR (Augmented Reality) function. The HMI 31 can also use a display device provided in the vehicle 1, such as a navigation device, an instrument panel, a CMS (Camera Monitoring System), an electronic mirror, a lamp, and the like, as an output device for outputting visual information.

As an output device from which the HMI 31 outputs auditory information, for example, audio speakers, headphones, and earphones can be applied.

As an output device from which the HMI 31 outputs tactile information, for example, a haptic element using haptic technology can be applied. A haptic element is provided at a portion of the vehicle 1 that is in contact with an occupant, such as a steering wheel or a seat.

The vehicle control unit 32 controls each unit of the vehicle 1. The vehicle control unit 32 includes the steering control unit 81, the brake control unit 82, the drive control unit 83, a body system control unit 84, a light control unit 85, and a horn control unit 86.

The steering control unit 81 performs detection, control, and the like of a state of a steering system of the vehicle 1. The steering system includes, for example, a steering mechanism including the steering wheel and the like, electronic power steering, and the like. For example, the steering control unit 81 includes a steering ECU which controls the steering system, an actuator which drives the steering system, and the like.

The brake control unit 82 performs detection, control, and the like of a state of a brake system of the vehicle 1. For example, the brake system includes a brake mechanism including a brake pedal and the like, an ABS (Antilock Brake System), a regenerative brake mechanism, and the like. For example, the brake control unit 82 includes a brake ECU that controls the brake system, an actuator which drives the brake system, and the like.

The drive control unit 83 performs detection, control, and the like of a state of a drive system of the vehicle 1. For example, the drive system includes an accelerator pedal, a drive force generating apparatus for generating a drive force such as an internal-combustion engine or a drive motor, a drive force transmission mechanism for transmitting the drive force to the wheels, and the like. For example, the drive control unit 83 includes a drive ECU that controls the drive system, an actuator which drives the drive system, and the like.

The body system control unit 84 performs detection, control, and the like of a state of a body system of the vehicle 1. For example, the body system includes a keyless entry system, a smart key system, a power window apparatus, a power seat, an air conditioner, an airbag, a seatbelt, and a shift lever. For example, the body system control unit 84 includes a body system ECU that controls the body system, an actuator that drives the body system, and the like.

The light control unit 85 performs detection, control, and the like of a state of various lights of the vehicle 1. As lights to be a control target, for example, a headlamp, a tail lamp, a fog lamp, a turn signal, a brake lamp, a projector lamp, and a bumper display are assumed. The light control unit 85 includes a light ECU that controls the light, an actuator which drives the lights, and the like.

The horn control unit 86 performs detection, control, and the like of a state of a car horn of the vehicle 1. For example, the horn control unit 86 includes a horn ECU which controls the car horn, an actuator which drives the car horn, and the like.

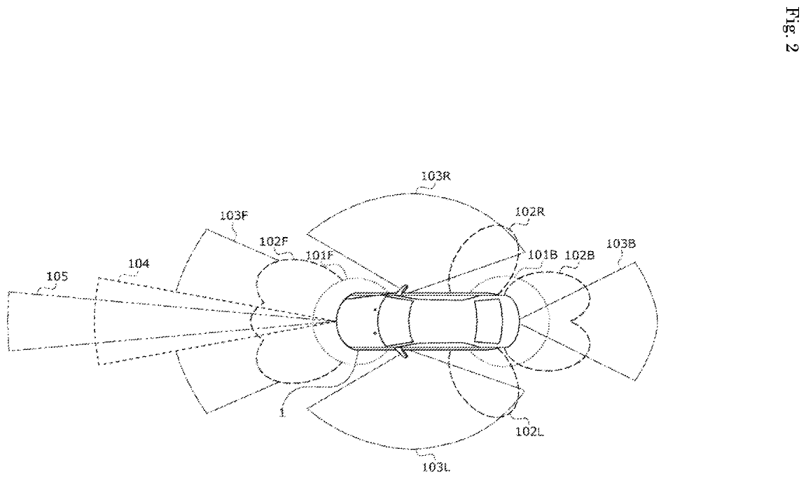

FIG. 2 is a diagram showing an example of sensing areas by the camera 51, the radar 52, the LiDAR 53, the ultrasonic sensor 54, and the like of the external recognition sensor 25 in FIG. 1. FIG. 2 schematically shows the vehicle 1 viewed from above, the left end side is the front end (front) side of the vehicle 1, and the right end side is the rear end (rear) side of the vehicle 1.

A sensing area 101F and a sensing area 101B represent an example of sensing areas of the ultrasonic sensor 54. The sensing area 101F covers the periphery of the front end of the vehicle 1 with a plurality of ultrasonic sensors 54. The sensing area 101B covers the periphery of the rear end of the vehicle 1 with a plurality of ultrasonic sensors 54.

Sensing results in the sensing area 101F and the sensing area 101B are used to provide the vehicle 1 with parking assistance or the like.

A sensing area 102F to a sensing area 102B represent an example of sensing areas of the radar 52 for short or intermediate distances. The sensing area 102F covers up to a position farther than the sensing area 101F in front of the vehicle 1. The sensing area 102B covers up to a position farther than the sensing area 101B to the rear of the vehicle 1. The sensing area 102L covers the periphery toward the rear of a left-side surface of the vehicle 1. The sensing area 102R covers the periphery toward the rear of a right side surface of the vehicle 1.

A sensing result in the sensing area 102F is used to detect, for example, a vehicle, a pedestrian, or the like present in front of the vehicle 1. A sensing result in the sensing area 102B is used by, for example, a function of preventing a collision to the rear of the vehicle 1. Sensing results in the sensing area 102L and the sensing area 102R are used to detect, for example, an object present in a blind spot to the sides of the vehicle 1.

A sensing area 103F to a sensing area 103B represent an example of sensing areas by the camera 51. The sensing area 103F covers up to a position farther than the sensing area 102F in front of the vehicle 1. The sensing area 103B covers a position farther than the sensing area 102B behind the vehicle 1. The sensing area 103L covers a periphery of the left-side surface of the vehicle 1. The sensing area 103R covers a periphery of the right side surface of the vehicle 1.

For example, a sensing result in the sensing area 103F can be used to recognize a traffic light or a traffic sign, used by a lane deviation prevention support system, and an automatic headlight control system. A sensing result in the sensing area 103B can be used for parking assistance and a surround view system, for example. Sensing results in the sensing area 103L and the sensing area 103R can be used, for example, in a surround view system.

A sensing area 104 represents an example of a sensing area of the LiDAR 53. The sensing area 104 covers up to a position farther than the sensing area 103F in front of the vehicle 1. On the other hand, the sensing area 104 has a narrower range in a left-right direction than the sensing area 103F.

Sensing results in the sensing area 104 are used, for example, to detect objects such as surrounding vehicles.

A sensing area 105 represents an example of a sensing area of the radar 52 for long distances. The sensing area 105 covers up to a position farther than the sensing area 104 in front of the vehicle 1. On the other hand, the sensing area 105 has a narrower range in the left-right direction than the sensing area 104.

The sensing result in the sensing area 105 is used, for example, for ACC (Adaptive Cruise Control), emergency braking, collision avoidance, and the like.

The sensing areas of the camera 51, the radar 52, the LiDAR 53, and the ultrasonic sensor 54 included in the external recognition sensor 25 may have various configurations other than those shown in FIG. 2. Specifically, the ultrasonic sensor 54 may be configured to also sense the sides of the vehicle 1 or the LiDAR 53 may be configured to also sense the rear of the vehicle 1. Moreover, the installation position of each sensor is not limited to each example mentioned above. In addition, the number of each sensor may be one or plural.

The present technology can be applied to the LiDAR 53, for example.

### 2. Embodiment

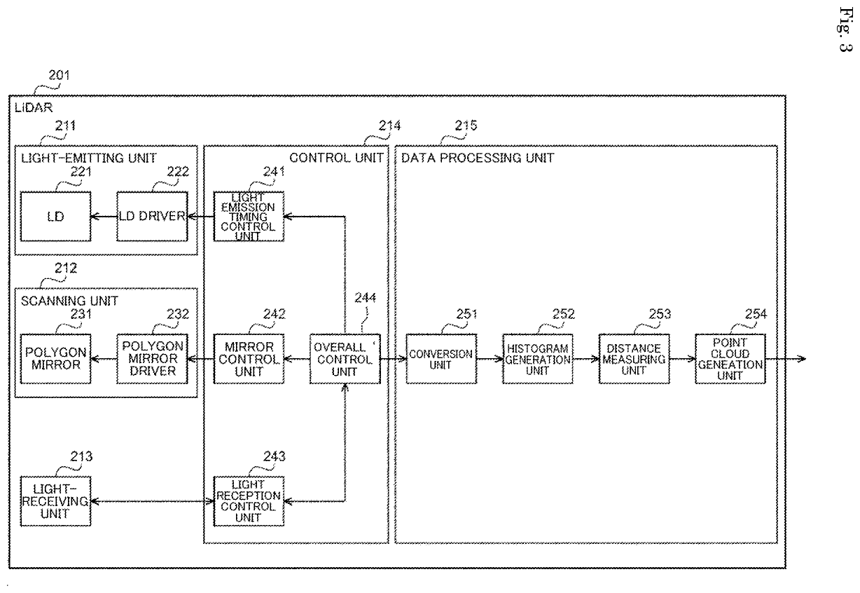

Next, embodiments of the present technology will be described with reference to FIGS. 3 to 9.

### <Configuration Example of LiDAR 211>

FIG. 3 shows an embodiment of the LiDAR 211 to which the present technology is applied.

The LiDAR 211 is, for example, a dToF (Direct Time of Flight) LiDAR. The LiDAR 211 includes a light-emitting unit 211, a scanning unit 212, a light-receiving unit 213, a control unit 214 and a data processing unit 215. The light-emitting unit 211 includes an LD (Laser Diode) 221 and an LD driver 222. The scanning unit 212 has a polygon mirror 231 and a polygon mirror driver 232. The control unit 214 includes a light emission timing control unit 241, a mirror control unit 242, a light reception control unit 243 and an overall control unit 244. The data processing unit 215 includes a conversion unit 251, a histogram generation unit 252, a distance measuring unit 253 and a point cloud generation unit 254.

The LD 221 emits pulsed laser light (hereinafter referred to as irradiation light) under the control of the LD driver 222.

The LD driver 222 drives the LD 221 in units of a predetermined time At under the control of the light emission timing control unit 241.

The polygon mirror 231 reflects the incident light from the LD 221 while rotating about a predetermined axis under the control of the polygon mirror driver 232. In this way, the irradiation light is scanned in the left-right direction (horizontal direction).

Here, the coordinate system of the LiDAR 201 (hereinafter referred to as the LiDAR coordinate system) is defined by, for example, mutually orthogonal X-, Y-, and Z-axes. The X-axis is, for example, an axis parallel to the left-right direction (horizontal direction) of the LiDAR 211. Therefore, the scanning direction of the irradiation light is the X-axis direction. The Y-axis is, for example, an axis parallel to the vertical direction (longitudinal direction) of the LiDAR 11. The Z-axis is, for example, an axis parallel to the front-rear direction (depth direction, distance direction) of the LiDAR 211.

The polygon mirror driver 232 drives the polygon mirror 231 under the control of the mirror control unit 242.

The light-receiving unit 213 includes, for example, a pixel array unit in which pixels in which SPADs (Single Photon Avalanche Diodes) are two-dimensionally arranged are arranged in a predetermined direction.

Here, the coordinate system of the pixel array unit of the light-receiving unit 213 is defined by, for example, the x-axis and the y-axis. The x-axis direction is the direction corresponding to the X-axis direction of the LiDAR coordinate system, and the y-axis direction is the direction corresponding to the Y-axis direction of the LiDAR coordinate system. In the pixel array unit, each pixel is arranged in the y-axis direction.

Each pixel of the light-receiving unit 213 receives incident light including reflected light that is the light reflected by an object under the control of the light reception control unit 243. The light-receiving unit 213 supplies a pixel signal indicating the intensity of incident light received by each pixel to the light reception control unit 243.

The light emission timing control unit 241 controls the LD driver 222 under the control of the overall control unit 244 to control the light emission timing of the LD 221.

The mirror control unit 242 controls the polygon mirror driver 232 under the control of the overall control unit 244 to control scanning of the irradiation light by the polygon mirror 231.

The light reception control unit 243 drives the light-receiving unit 213. The light reception control unit 243 supplies the pixel signal of each pixel supplied from the light-receiving unit 213 to the overall control unit 244.

The overall control unit 244 controls the light emission timing control unit 241, the mirror control unit 242 and the light reception control unit 243. In addition, the overall control unit 244 supplies the pixel signal supplied from the light reception control unit 243 to the conversion unit 251.

The conversion unit 251 converts the pixel signal supplied from the overall control unit 244 into a digital signal, and supplies the digital signal to the histogram generation unit 252.

The histogram generation unit 252 generates a histogram showing the time-series distribution of the intensity of incident light from each predetermined unit field of view. The histogram of each unit field of view indicates, for example, the time-series distribution of the intensity of incident light from each unit field of view from the time when irradiation light for each unit field of view was emitted.

Here, the position of each unit field of view is defined by the positions in the X-axis direction and the Y-axis direction of the LiDAR coordinate system.

For example, the irradiation light is scanned within a predetermined range (hereinafter referred to as scanning range) in the X-axis direction. Then, distance measurement processing is performed for each unit field of view having a predetermined viewing angle 40 in the X-axis direction. For example, if the scanning range of the irradiation light is within the range of −60° to 60° and the viewing angle of the unit field of view is 0.2°, the number of unit fields of view in the X-axis direction is 600 (=120°/0.2°). The viewing angle of the unit field of view in the X-axis direction is the resolution of the LiDAR 211 in the X-axis direction. The resolution in the X-axis direction of the LiDAR 211 corresponds to, for example, the pixel pitch in the x-axis direction of the pixel array unit of the light-receiving unit 213.

Each pixel of the pixel array unit of the light-receiving unit 213 receives, for example, reflected light from different unit fields of view in the Y-axis direction. Therefore, the number of unit fields of view in the Y-axis direction is equal to the number of pixels in the y-axis direction of the pixel array unit of the light-receiving unit 213. For example, when the number of pixels in the y-axis direction of the pixel array unit is 64, the number of unit fields of view in the Y-axis direction is 64. The viewing angle of the unit field of view in the Y-axis direction is the resolution of the LiDAR 211 in the Y-axis direction.

In this manner, the irradiation range of the irradiation light is divided into unit fields of view that are two-dimensionally arranged in the X-axis direction and the Y-axis direction. Then, distance measurement processing is performed for each unit field of view.

The histogram generation unit 252 supplies the histogram data corresponding to each unit field of view to the distance measuring unit 253.

The distance measuring unit 253 measures the distance (depth) in the Z-axis direction to the reflection point of the irradiation light in each unit field of view based on the histogram of each unit field of view. For example, the distance measuring unit 253 creates an approximate curve of the histogram and detects the peak of the approximate curve. The time at which this approximate curve peaks is the time from when the irradiation light is emitted until when the reflected light is received. The distance measuring unit 253 converts the peak time of the approximate curve of each histogram into the distance to the reflection point where the irradiation light is reflected. The distance measuring unit 253 supplies information indicating the distance to the reflection point in each unit field of view to the point cloud generation unit 254.

The point cloud generation unit 254 generates a point cloud (point cloud data) representing the distribution of each reflection point in the LiDAR coordinate system based on the distance to each reflection point in each unit field of view. The point cloud generation unit 254 outputs data representing the generated point cloud to a subsequent device.

### <Configuration Example of Optical System of LiDAR 211>

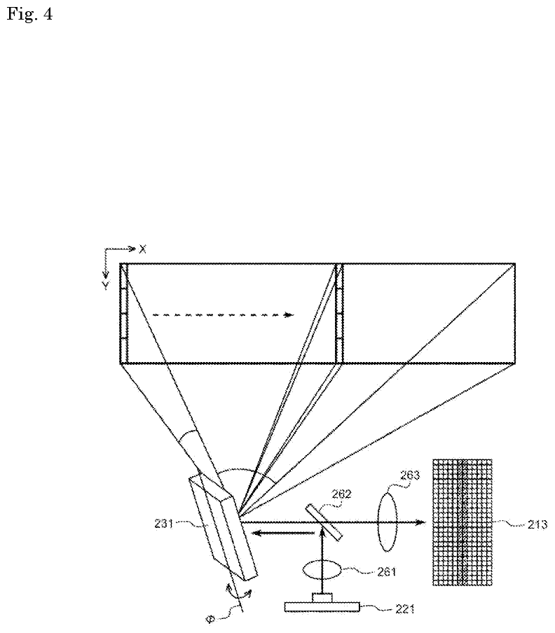

FIG. 4 shows a configuration example of the optical system of the LiDAR 211.

The LiDAR 211 includes a lens 261, a folding mirror 262, and a lens 263 in addition to the configuration described above with reference to FIG. 3.

Irradiation light emitted from the LD 221 is spread by the lens 261 in a direction corresponding to the Y-axis direction of the LiDAR coordinate system, and then reflected by the folding mirror 262 toward the polygon mirror 231. The polygon mirror 231 reflects the irradiation light while rotating in the X-axis direction about the axis φ, thereby radially scanning the irradiation light elongated in the Y-axis direction in the X-axis direction.

Incident light including the reflected light reflected by an object existing within the scanning range of the irradiation light enters the polygon mirror 231 and is reflected by the polygon mirror 231 toward the folding mirror 262. The incident light reflected by the polygon mirror 231 passes through the folding mirror 262, is collected by the lens 263, and enters the light-receiving unit 213.

### First Embodiment for Increasing Resolution of LiDAR 211

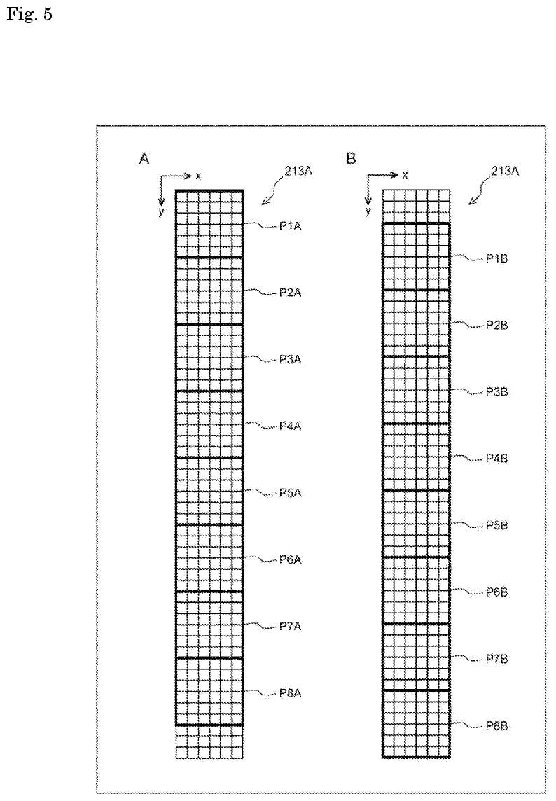

Next, a first embodiment for increasing the resolution of the LiDAR 211 will be described with reference to FIG. 5.

FIG. 5 shows a configuration example of the pixel array unit 213A of the light-receiving unit 213 of the LiDAR 211. Small square frames in FIGS. 5A and 5B indicate the positions of SPADs. Large thick square frames in FIGS. 5A and 5B indicate the positions of pixels.

Specifically, in the pixel array unit 213A, SPADs are two-dimensionally arranged in the x-axis direction and the y-axis direction. The x-axis direction of the pixel array unit 213A corresponds to the scanning direction of the irradiation light, and the y-axis direction of the pixel array unit 213A corresponds to the direction in which the irradiation light extends. In addition, one pixel is configured by a predetermined number of SPADs in the x-axis direction and the y-axis direction. In this example, one pixel is composed of 36 SPADs, six in the x-axis direction and six in the y-axis direction. Each pixel is arranged in the y-axis direction.

Each pixel then outputs a pixel signal that indicates the intensity of the incident light based on the number of SPADs that have received photons.

Here, as shown in A and B of FIG. 5, the light-receiving unit 213 can shift the positions of the pixels of the pixel array unit 213A under the control of the light reception control unit 243.

For example, in the example of A of FIG. 5, eight pixels P1A to P8A are arranged in the y-axis direction. On the other hand, in the example of B of FIG. 5, pixels P1B to P8B are arranged at positions shifted in the y-axis direction by ½ of the pixel pitch from the pixels P1A to P8A.

For example, the light reception control unit 243 shifts the positions of the pixels of the pixel array unit 213A in the y-axis direction for each frame under the control of the overall control unit 244. For example, the light reception control unit 243 sets the pixel position to the position shown in A of FIG. 5 in odd-numbered frames, and sets the pixel position to the position shown in B of FIG. 5 in even-numbered frames.

As a result, the pixel pitch in the y-axis direction of the pixel array unit 213A is substantially halved, and the pitch between the unit fields of view in the Y-axis direction is substantially halved. As a result, the resolution of the LiDAR 211 in the Y-axis direction is substantially halved, and the resolution of the LiDAR 211 can be improved while suppressing the number of SPADs in the pixel array unit 213A.

Note that, for example, the point cloud generation unit 254 may synthesize the point cloud generated in the odd-numbered frame and the point cloud generated in the even-numbered frame. This allows the point cloud to be finer.

Further, the shift amount in the y-axis direction of the position of the pixel in the pixel array unit 213A is not limited to ½ of the pixel pitch. For example, the shift amount of the pixel position in the y-axis direction may be ⅓ or more and ⅔ or less of the pixel pitch. In other words, the shift amount in the Y-axis direction of the positions of the unit fields of view may be ⅓ or more and ⅔ or less of the pitch between the unit fields of view in the Y-axis direction.

### Second Embodiment for Increasing Resolution of LiDAR 211

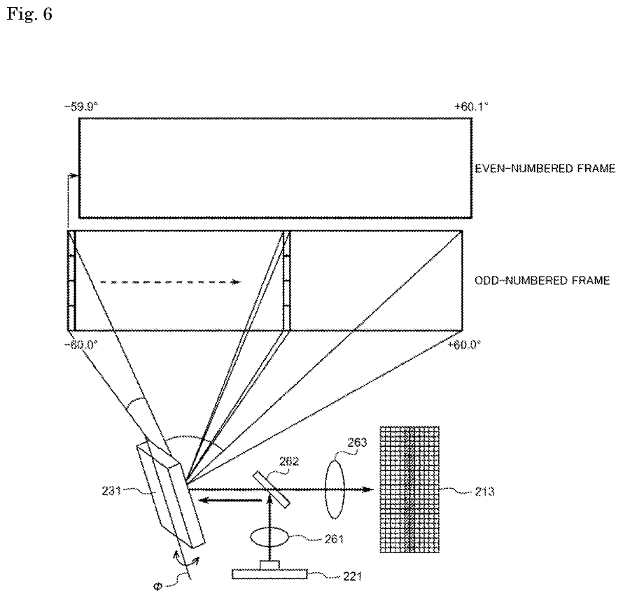

Next, a second embodiment for increasing the resolution of the LiDAR 211 will be described with reference to FIG. 6.

In the following description, it is assumed that the viewing angle of the unit field of view in the X-axis direction is 0.2°. Therefore, the resolution of the LiDAR 211 in the X-axis direction is 0.2°.

For example, the light emission timing control unit 241 drives the LD driver 222 to change the light emission timing of the LD 221 so that the irradiation direction of the irradiation light is shifted in the X-axis direction by ½ of the viewing angle of the unit field of view, that is, 0.1°, which is ½ of the resolution of LiDAR 211, between frames. As a result, the scanning range of the irradiation light and the unit field of view are shifted by 0.1° in the X-axis direction between frames.

For example, as shown in FIG. 6, in odd-numbered frames, the scanning range of the irradiation light is set to the range of −60.0° to +60.0° in the X-axis direction. Then, the scanning range of −60.0° to +60.0° is divided into unit fields of view every 0.2° in the X-axis direction. On the other hand, in even-numbered frames, the scanning range of the irradiation light is set to the range of −59.9° to +60.1° in the X-axis direction. Then, the scanning range of −59.9° to +60.1° is divided into unit fields of view every 0.2° in the X-axis direction. As a result, the position of the unit field of view is shifted by 0.1° in the X-axis direction between the odd-numbered frames and the even-numbered frames.

In addition, the light reception control unit 243 changes the timing of driving the light-receiving unit 213 in accordance with the change of the emission timing of the irradiation light of the LD 221 between frames.

As a result, the pitch between the unit fields of view in the X-axis direction is substantially halved. As a result, the resolution of the LiDAR 211 in the X-axis direction is substantially halved (0.1°), and the resolution of the LiDAR 211 can be improved while suppressing the number of SPADs in the pixel array unit 213A.

Note that, for example, the mirror control unit 242 may drive the polygon mirror driver 232 so that the irradiation direction of the irradiation light is shifted by 0.1° in the X-axis direction between frames, and the scanning timing of the irradiation light by the polygon mirror 231 is changed.

Further, for example, both the light emission timing and the scanning timing of the irradiation light may be changed so that the irradiation direction of the irradiation light is shifted by 0.1° between frames.

Further, for example, the point cloud generation unit 254 may synthesize the point cloud generated in the odd-numbered frames and the point cloud generated in the even-numbered frames. This allows the point cloud to be finer.

Further, the shift amount in the X-axis direction of the irradiation direction of the irradiation light is not limited to ½ of the resolution of the LiDAR 211 in the X-axis direction. For example, the shift amount in the X-axis direction of the irradiation direction of the irradiation light may be ⅓ or more and ⅔ or less of the resolution in the X-axis direction of the LiDAR 211. In other words, the shift amount in the X-axis direction of the positions of the unit fields of view may be ⅓ or more and ⅔ or less of the pitch between the unit fields of view in the X-axis direction.

### Third Embodiment for Increasing Resolution of LiDAR 211

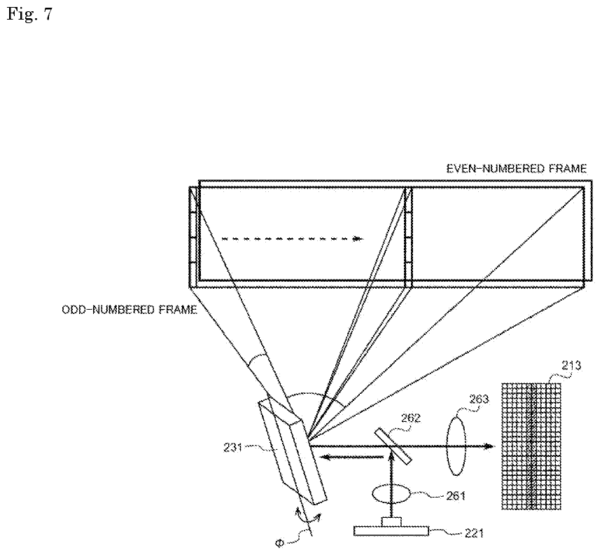

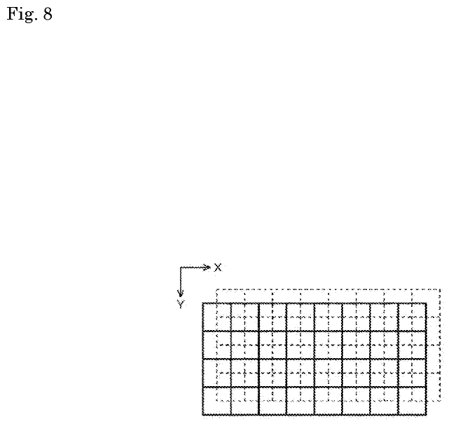

Next, a third embodiment for increasing the resolution of the LiDAR 211 will be described with reference to FIGS. 7 and 8. In the third embodiment, the first embodiment and the second embodiment are combined.

Specifically, between frames, the positions of the pixels of the light-receiving unit 213 are shifted in the y-axis direction by ½ of the pixel pitch, and the irradiation direction of the irradiation light is shifted in the X-axis direction by ½ of the viewing angle of the unit field of view.

In this way, as schematically shown in FIG. 7, the irradiation range of the irradiation light is shifted in the X-axis direction and the Y-axis direction between the odd-numbered frames and the even-numbered frames.

FIG. 8 schematically shows the positions of the unit fields of view in odd-numbered frames and even-numbered frames. Each solid-line frame indicates the position of the unit field of view in the odd-numbered frame, and each dotted-line frame indicates the position of the unit field of view in the even-numbered frame.

In this way, between odd-numbered frames and even-numbered frames, the positions of the unit fields of view are shifted in the X-axis direction by ½ of the pitch between the unit fields of view, and shifted in the Y-axis direction by ½ of the pitch between the unit fields of view.

As a result, the diagonal pitch between the unit fields of view is substantially halved. As a result, the resolution of the LiDAR 211 is substantially halved, and the resolution of the LiDAR 211 can be improved while suppressing the number of SPADs in the pixel array unit 213A.

Note that, for example, the point cloud generation unit 254 may synthesize the point cloud generated in the odd-numbered frames and the point cloud generated in the even-numbered frames. This allows the point cloud to be finer.

Further, the shift amount in the y-axis direction of the position of the pixel in the pixel array unit 213A is not limited to ½ of the pixel pitch. For example, the shift amount of the pixel position in the y-axis direction may be ⅓ or more and ⅔ or less of the pixel pitch. The shift amount in the X-axis direction of the irradiation direction of the irradiation light is not limited to ½ of the resolution in the X-axis direction of the LiDAR 211. For example, the shift amount in the X-axis direction of the irradiation direction of the irradiation light may be ⅓ or more and ⅔ or less of the resolution in the X-axis direction of the LiDAR 211. In other words, the shift amount of the position of the unit field of view in the X-axis direction and the Y-axis direction may be ⅓ or more and ⅔ or less of the pitch between the unit fields of view in the X-axis direction and the Y-axis direction.

### Fourth Embodiment for Increasing Resolution of LiDAR 211

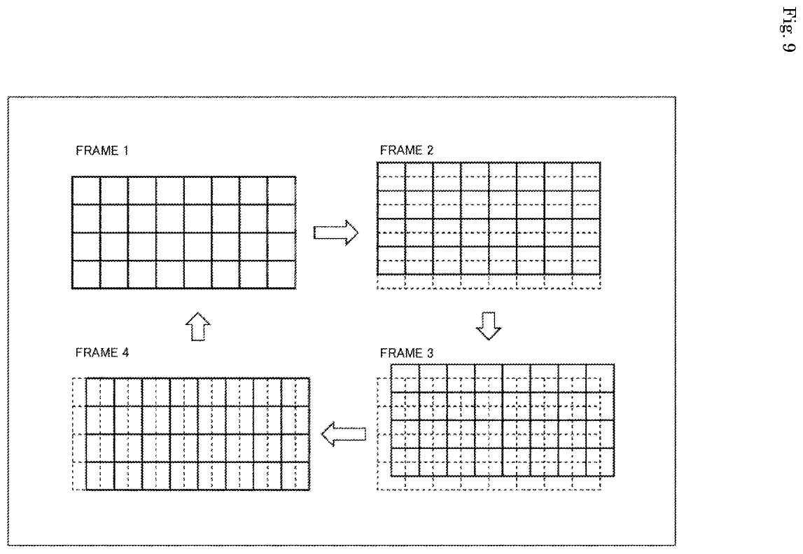

Next, a fourth embodiment for increasing the resolution of the LiDAR 211 will be described with reference to FIG. 9.

In the fourth embodiment, the above-described first embodiment and second embodiment are alternately executed in units of four frames.

Specifically, FIG. 9 schematically shows the positions of the unit fields of view in frames 1 to 4, which are the first to fourth frames in a unit of four frames, similarly to FIG. 8. Each solid-line frame indicates the position of the unit field of view in each frame, and each dotted-line frame indicates the position of the unit field of view in frame 1.

For example, the first embodiment described above is executed between frame 1 and frame 2, and the positions of the pixels in the pixel array unit 213A are shifted in the y-axis direction by ½ of the pixel pitch. As a result, the positions of the unit fields of view are shifted in the Y-axis direction by ½ of the pitch between the unit fields of view.

Next, the above-described second embodiment is performed between frames 2 and 3, and the positions of the unit fields of view are shifted in the X-axis direction by ½ of the pitch between the unit fields of view.

Next, the first embodiment described above is executed between frames 3 and 4, and the positions of the pixels in the pixel array unit 213A are shifted by ½ of the pixel pitch in the opposite direction from the direction between frames 1 and 2. As a result, the position of the unit field of view in the Y-axis direction returns to the same position as in frame 1.

Next, the second embodiment described above is performed between frame 4 and frame 1 of the next group, and the positions of the unit fields of view are shifted by ½ of the pitch between the unit fields of view in the opposite direction from the direction between from frame 1 to frame 2. As a result, the position of the unit field of view in the X-axis direction returns to the same position as in frame 1.

The above processing is repeatedly executed every four frames. That is, the processing in which the positions of the unit fields of view are shifted in one of the positive direction and the negative direction of the Y-axis by ½ of the pitch between the unit fields of view in an even-numbered frame, the positions are shifted in the other direction of the Y-axis by ½ of the pitch between the unit fields of view in the next even-numbered frame, the positions are shifted in one of the positive and negative directions of the X-axis by ½ of the pitch between the unit fields of view in an odd-numbered frame, and the positions are shifted in the other direction of the X-axis by ½ of the pitch between the unit fields of view in the next odd-numbered frame is repeated.

As a result, the pitches between the unit fields of view in the X-axis direction and the Y-axis direction are each substantially halved. As a result, the resolution of the LiDAR 211 in the X-axis direction and the Y-axis direction is substantially halved, and the resolution of the LiDAR 211 can be improved while suppressing the number of SPADs in the pixel array unit 213A.

Note that, for example, the direction in which the unit field of view is shifted in even-numbered frames and the direction in which the unit field of view is shifted in odd-numbered frames may be reversed. That is, the unit field of view may be shifted in the X-axis direction in even-numbered frames, and the unit field of view may be shifted in the Y-axis direction in odd-numbered frames.

In addition, for example, the point cloud generation unit 254 may synthesize the point clouds respectively generated in the above four frames. This allows the point cloud to be finer.

### 3. Modification Examples

Hereinafter, modification examples of the foregoing embodiments of the present technique will be described.

In the above description, the shift amount of the pixel positions in the pixel array unit 213A can be set to any value within a range smaller than the pixel pitch. For example, the shift amount of the pixel position may be set to ⅓ of the pixel pitch, and the pixel position may be returned to the original position every three frames. As a result, the pixel pitch of the light-receiving unit 213 is substantially reduced to ⅓, and the resolution of the LiDAR 211 in the Y-axis direction is substantially reduced to ⅓.

In the above description, the shift amount in the irradiation direction of the irradiation light in the X-axis direction can be set to any value within a range smaller than the resolution of the LiDAR 211 in the X-axis direction. For example, the shift amount of the irradiation direction of the irradiation light may be set to ⅓ of the resolution in the X-axis direction, and the irradiation direction of the irradiation light may be returned to the original direction every three frames. As a result, the pitch between the unit fields of view in the X-axis direction is substantially reduced to ⅓, and the resolution of the LiDAR 211 in the X-axis direction is substantially reduced to ⅓.

For example, the resolution of the LiDAR 211 in the X-axis direction may be increased by increasing the number of SPADs in the x-axis direction of the light-receiving unit 213 and shifting the pixel positions of the light-receiving unit 213 in the x-axis direction.

For example, an APD (avalanche photodiode), a highly sensitive photodiode, or the like can be used for the light-receiving element of the pixel array unit 213A. The scanning method of irradiation light is not limited to the example described above, and other methods can be applied. For example, the irradiation light may be scanned using rotating mirrors, galvanometer mirrors, Risley prisms, MMT (Micro Motion Technology), head spin, MEMS (Micro-Electro-Mechanical Systems) mirrors, OPA (Optical Phased Array), liquid crystals, VCSEL (Vertical Cavity Surface Emitting Laser), array scanning or the like.

For example, the irradiation light may be shaped to extend in the X-axis direction, and the irradiation light may be scanned in the Y-axis direction.

In addition to LiDAR, the present technology can be applied to a distance measuring device that scans irradiation light and measures a distance based on incident light including reflected light of the irradiation light.

### 4. Others

The above-described series of processing can also be performed by hardware or software. When the series of steps of processing is performed by software, a program of the software is installed in a computer. Here, the computer includes a computer embedded in dedicated hardware or, for example, a general-purpose personal computer capable of executing various functions by installing various programs.

A program to be executed by a computer can be provided by being recorded on a removable medium such as a package medium, for example. The program can also be provided via a wired or wireless transmission medium such as a local area network, the Internet, or digital satellite broadcasting.

Embodiments of the present technology are not limited to the above-described embodiments and can be changed variously within the scope of the present technology without departing from the gist of the present technology.

### <Combination Example of Configuration>

The present technology can also have the following configuration.

(1)

A distance measuring device including:
a light source that emits pulsed irradiation light;
a scanning unit that scans the irradiation light in a first direction;
a light-receiving unit that receives incident light including reflected light with respect to the irradiation light;
a distance measuring unit that performs distance measurement based on the incident light; and
a control unit that shifts an irradiation direction of the irradiation light in the first direction within a range smaller than a resolution in the first direction between frames by controlling at least one of the light source and the scanning unit.
   (2)

The distance measuring device according to (1), wherein
the light-receiving unit has a pixel array unit in which pixels each having a plurality of light-receiving elements arranged two-dimensionally are arranged in a third direction perpendicular to a second direction corresponding to the first direction, and
the control unit shifts positions of the pixels in the pixel array unit in the third direction within a range smaller than a pixel pitch between frames.
   (3)

The distance measuring device according to (2), wherein
the control unit shifts the irradiation direction of the irradiation light in the first direction by ½ of the resolution in the first direction between frames, and shifts the positions of the pixels in the pixel array unit in the third direction by ½ of the pixel pitch.
   (4)

The distance measuring device according to (2), wherein
the control unit shifts the irradiation direction of the irradiation light in the first direction by ½ of the resolution in the first direction in one of odd-numbered frames and even-numbered frames and shifts the positions of the pixels in the pixel array unit in the third direction by ½ of the pixel pitch in the other frames.
   (5)

The distance measuring device according to any one of (2) to (4), wherein
in each of the pixels, the light-receiving elements are arranged in the second direction and the third direction.
   (6)

The distance measuring device according to any one of (2) to (5), wherein
the light-receiving element is a SPAD (Single Photon Avalanche Diode).
   (7)

The distance measuring device according to any one of (2) to (6), wherein
the resolution in the first direction corresponds to a pixel pitch in the second direction of the pixel array unit.
   (8)

The distance measuring device according to (1), wherein
the control unit shifts the irradiation direction of the irradiation light by a predetermined shift amount in the first direction between frames, and
the shift amount is ⅓ or more and ⅔ or less of the resolution in the first direction.
   (9)

The distance measuring device according to (8), wherein
the shift amount is ½ of the resolution in the first direction.
   (10)

The distance measuring device according to any one of (1) to (9), wherein
the control unit shifts the irradiation direction of the irradiation light to the first direction by controlling at least one of a timing of emitting the irradiation light from the light source and a timing of scanning the irradiation light by the scanning unit.
   (11)

The distance measuring device according to any one of (1) to (10), wherein
the irradiation light extends long in a direction perpendicular to the first direction.
   (12)

The distance measuring device according to any one of (1) to (11), wherein
the first direction is a left-right direction.
   (13)

A distance measuring method in a distance measuring device including:
a light source that emits pulsed irradiation light;
a scanning unit that scans the irradiation light in a predetermined direction;
a light-receiving unit that receives incident light including reflected light with respect to the irradiation light; and
a distance measuring unit that performs distance measurement based on the incident light, the distance measuring device executing:
shifting an irradiation direction of the irradiation light in the predetermined direction within a range smaller than a resolution in the predetermined direction between frames by controlling at least one of the light source and the scanning unit.

The advantageous effects described in the present specification are merely exemplary and are not limited, and other advantageous effects may be obtained.

### REFERENCE SIGNS LIST

201 LiDAR
211 Light-emitting unit
212 Scanning unit
213 Light-receiving unit
213A Pixel array unit
214 Control unit
215 Data processing unit
221 LD
222 LD driver
231 Polygon mirror
232 Polygon mirror driver
241 Light emission timing control unit
242 Mirror control unit
243 Light reception control unit
244 Overall control unit
252 Histogram generation unit
253 Distance measuring unit
254 Point cloud generation unit

1. A distance measuring device comprising:
a light source that emits pulsed irradiation light;
a scanning unit that scans the irradiation light in a first direction;
a light-receiving unit that receives incident light including reflected light with respect to the irradiation light;
a distance measuring unit that performs distance measurement based on the incident light; and
a control unit that shifts an irradiation direction of the irradiation light in the first direction within a range smaller than a resolution in the first direction between frames by controlling at least one of the light source and the scanning unit.

2. The distance measuring device according to claim 1, wherein
the light-receiving unit has a pixel array unit in which pixels each having a plurality of light-receiving elements arranged two-dimensionally are arranged in a third direction perpendicular to a second direction corresponding to the first direction, and
the control unit shifts positions of the pixels in the pixel array unit in the third direction within a range smaller than a pixel pitch between frames.

3. The distance measuring device according to claim 2, wherein
the control unit shifts the irradiation direction of the irradiation light in the first direction by ½ of the resolution in the first direction between frames, and shifts the positions of the pixels in the pixel array unit in the third direction by ½ of the pixel pitch.

4. The distance measuring device according to claim 2, wherein
the control unit shifts the irradiation direction of the irradiation light in the first direction by ½ of the resolution in the first direction in one of odd-numbered frames and even-numbered frames and shifts the positions of the pixels in the pixel array unit in the third direction by ½ of the pixel pitch in the other frames.

5. The distance measuring device according to claim 2, wherein
in each of the pixels, the light-receiving elements are arranged in the second direction and the third direction.

6. The distance measuring device according to claim 2, wherein
the light-receiving element is a SPAD (Single Photon Avalanche Diode).

7. The distance measuring device according to claim 2, wherein
the resolution in the first direction corresponds to a pixel pitch in the second direction of the pixel array unit.

8. The distance measuring device according to claim 1, wherein
the control unit shifts the irradiation direction of the irradiation light by a predetermined shift amount in the first direction between frames, and
the shift amount is ⅓ or more and ⅔ or less of the resolution in the first direction.

9. The distance measuring device according to claim 8, wherein
the shift amount is ½ of the resolution in the first direction.

10. The distance measuring device according to claim 1, wherein
the control unit shifts the irradiation direction of the irradiation light to the first direction by controlling at least one of a timing of emitting the irradiation light from the light source and a timing of scanning the irradiation light by the scanning unit.

11. The distance measuring device according to claim 1, wherein
the irradiation light extends long in a direction perpendicular to the first direction.

12. The distance measuring device according to claim 1, wherein
the first direction is a left-right direction.

13. A distance measuring method in a distance measuring device including:
a light source that emits pulsed irradiation light;
a scanning unit that scans the irradiation light in a predetermined direction;
a light-receiving unit that receives incident light including reflected light with respect to the irradiation light; and
a distance measuring unit that performs distance measurement based on the incident light, the distance measuring device executing:
shifting an irradiation direction of the irradiation light in the predetermined direction within a range smaller than a resolution in the predetermined direction between frames by controlling at least one of the light source and the scanning unit.
